(19) United States
(12) Patent Application Publication
(10) Pub. No.: US 2024/0334949 A1
(43) Pub. Date: Oct. 10, 2024

(54) PRODUCTION METHOD FOR OBTAINING CHEESE FROM HAZELNUT MILK

(71) Applicant: BALSU GIDA SANAYI VE TICARET ANONIM SIRKETI, Sakarya (TR)

(72) Inventor: Emel OZENGEN, Sakarya (TR)

(73) Assignee: BALSU GIDA SANAYI VE TICARET ANONIM SIRKETI, Sakarya (TR)

(21) Appl. No.: 18/293,366

(22) PCT Filed: Aug. 4, 2022
(86) PCT No.: PCT/TR2022/050823

§ 371 Date: Jan. 30, 2024

(30) Foreign Application Priority Data
Sep. 15, 2021 (TR) 2021/014454

(51) Int. Cl. A23C 20/02; A23C 11/10

(52) U.S. Cl. CPC A23C 20/025; A23C 11/106

(57) ABSTRACT

Hazelnut cheese is provided. The hazelnut cheese does not include any animal product input in the production process steps for all consumers, particularly for vegan consumers, and any animal taste and odor, and the hazelnut cheese has high nutrient values and long shelf lifetime. The production method of said hazelnut cheeses is also provided.

### CROSS-REFERENCE TO THE RELATED APPLICATIONS

This application is the national phase entry of International Application No. PCT/TR2022/050823, filed on Aug. 4, 2022, which is based upon and claims priority to Turkish Patent Application No. 2021/014454, filed on Sep. 15, 2021, the entire contents of which are incorporated herein by reference.

### TECHNICAL FIELD

The present invention belongs to food sector technical field, and relates to hazelnut cheese which does not include any animal product input in the production process steps for all consumers, particularly for vegan consumers, and which does not include any animal taste and odor and which has high nutrient values and long shelf lifetime, and relates to the production method of said hazelnut cheeses.

### BACKGROUND

Cheese is a milk product made of various kinds of milks all around the world. Cheese is essentially obtained by coagulating of milk, by separating whey from the coagulation and afterwards by processing the coagulation in different forms. In cheese production, essentially, cow milk, sheep milk, goat milk and buffalo milk are used. Besides, in cheese production, cream, whey, buttermilk, recombined and reconstituted milks or the mixtures thereof can be used. For instance, cheese can be produced only from whey, and milks including different oil proportions are mixed with whey, and cheese (Ricotta) can be made from this mixture. Coagulation, which is one of the basic processes in cheese production, can be produced by using cheese ferment (photolytic enzyme) or harmless organic acids, and the usage thereof together is also possible. In some cases, also thermal process is used in obtaining the coagulation (as in whey cheese). Approximately 75% of the cheeses produced in the world are formed by cheeses obtained as a result of coagulation of milk with cheese ferment. Such cheeses are cheeses consumed after being maturated. The remaining 25% part is formed by the cheeses obtained as a result of coagulation of milk by means of harmless organic acids. Such cheeses are essentially consumed in a fresh manner.

Because of the thermal processes realized during cheese production and applied to milks used in obtaining cheese, the structure of the oils in its body is deteriorated and nutrient values of milks decreases. Besides, various synthetic additive substances are added for extending shelf lifetime of milks which are used in obtaining cheese after pasteurization processes and shelf lifetime of cheeses which are to be obtained as a result of production processes, this process leads to decrease of the nutrient values of cheeses and moreover accommodation of chemicals which form toxic effect.

In recent times, the studies rapidly continue which are related to products which do not include animal products for vegan feeding culture. Accordingly, various companies in food sector execute research and development activities in order to widen the product variety related to herbal-based milk products.

As a result, it is foreseen that cheese, obtained without including any animal raw material and which has long shelf lifetime without including any synthetic additive substance, shall provide the novelty criterion for the related technical field.

### SUMMARY

The present invention relates to production of hazelnut cheeses which have high nutrient values, for meeting the abovementioned requirements and for bringing some additional advantages for the technical field of cheese production in food sector.

An object of the present invention is to provide a production method for hazelnut cheese which has high nutrient values by being pasteurized without destructing oil, protein and other nutrients in milk composition during production.

An object of the present invention is to provide a production method for hazelnut cheese where animal sourced products are not used as input during production.

An object of the present invention is to provide a production method for hazelnut cheese where synthetic chemical compounds are not used as input during production.

An object of the present invention is to provide a production method for hazelnut cheese which has long shelf lifetime.

In order to realize all of these objects, the present invention is a production method for hazelnut cheese which does not include any animal product input and which does not include any animal taste and odor and which has high nutrient values and long shelf lifetime and where high value of foods in hazelnut is pasteurized in a manner destructed at the minimum level, characterized by comprising the steps of:
i) obtaining hazelnut milk from hazelnuts
   applying pre-cleaning processes for providing separation of galls and rotten from hazelnuts,
   adding the cleaned hazelnuts into water at a temperature between 5 and 15° C. and waiting,
   taking the wet hazelnut particles, removed from water, into mixer, grinder or stirrer devices and after adding water, fragmenting of hazelnuts by means of said devices, wherein said hazelnut/water proportion is configured such that it is at a value between ½ and ¼ grams/ml by volume,
   passing the obtained fragmented hazelnuts from milk cloth and obtaining hazelnut milk,
   applying thermal processes to the hazelnut milk separated from milk cloth,
ii) obtaining herbal ferments from chickpeas and obtaining yoghurt ferment
   boiling water with scale of at most 200 mL for chickpeas between 15 and 20 in number and cooling,
   adding chickpeas into water, adding salt and obtaining the mixture and wherein said mixture is incubated at a temperature between 40 and 45° C.,
   bringing the hazelnut milk, obtained in step i), to fermenting temperature, wherein said fermenting temperature is a temperature value between 40 and 45° C.,
   after the incubation process, the obtained chickpea ferment is added into the hazelnut milk brought to fermenting temperature and yoghurt ferment is obtained, wherein said chickpea ferment/hazelnut milk proportion is a value between 0.01/1 and 0.05/1 mL/mL by volume,
iii) obtaining hazelnut yoghurts as a result of fermenting of the hazelnut milks, obtained in step i), by chickpea ferments obtained in step ii)
   adding the yoghurt ferment, obtained in step ii), into hazelnut milks obtained in step i), wherein during the adding process, the yoghurt ferment and the hazelnut milks have temperature values between 40 and 45° C., wherein said yoghurt ferment/hazelnut milk proportion has a value between 0.01/1 and 0.03/1 mL/mL by volume,
   yoghurt fermenting process is realized, is waited at incubation temperature, the temperature of the waiting process has temperature values between 40 and 45° C.,
   the hazelnut yoghurt obtained after incubation process is left for cooling at temperature of +4° C.,
iv) adding hazelnut yoghurt, obtained in step iii), to the hazelnut milk obtained in step i) and obtaining hazelnut cheeses,
   heating the hazelnut milk, obtained in process step i), to a temperature between 90 and 95° C.,
   adding hazelnut yoghurt, obtained in process step iii), to the heated hazelnut milk, and obtaining the mixture, wherein the hazelnut milk/hazelnut yoghurt proportion is at a value between ⅕ and 1/10 grams/gram by weight,
   adding lemon to the obtained mixture and continuing mixing intermittently until the milk is curdled inside the mixture,
   adding 5 grams of salt at most during occurrence of agglomerations at the surface,
   waiting for completion of the processes after starting the boiling process and obtaining hazelnut cheese,
   filtering water during taking of hazelnut cheese and cooling.

In a possible embodiment of the present invention, hazelnut diameters are at a value between 10 and 12 mm.

In a possible embodiment of the present invention, hazelnuts are kept in cold water for at least 24 hours.

In a possible embodiment of the present invention, said milk cloth is at a maximum value of 50 microns.

In a possible embodiment of the present invention, said milk cloth is at a value of 30 microns.

In a possible embodiment of the present invention, said thermal process is realized at a fixed temperature between 70° C. and 95° C.

In a possible embodiment of the present invention, said thermal process is realized at a fixed temperature between 80° C. and 85° C.

In a possible embodiment of the present invention, the thermal process is realized for duration between 8 and 10 minutes.

In a possible embodiment of the present invention, in process step ii), said salt amount is at a value between 1 and 1.5 grams.

In a possible embodiment of the present invention, in process step ii), said incubation processes are realized for at least 12 hours.

In a possible embodiment of the present invention, in process step iii), said incubation processes are realized for at least 12 hours.

In a possible embodiment of the present invention, in step iv), after said boiling process starts, waiting process is applied for 5 minutes.

In a possible embodiment of the present invention, in step iv), the filtering process continues at least for 24 hours.

### DETAILED DESCRIPTION OF THE EMBODIMENTS

In this detailed description, the subject matter belongs to food sector technical field, and relates to hazelnut cheese which does not include any animal product input in the production process steps for all consumers, particularly for vegan consumers, and which does not include any animal taste and odor and which has high nutrient values and long shelf lifetime, and relates to the production method of said hazelnut cheeses, and is explained with references to examples without forming any restrictive effect only in order to make the subject more understandable.

For providing all characteristics, production of hazelnut cheese essentially comprises the process steps of:
i) obtaining hazelnut milk from hazelnuts,
ii) obtaining chickpea ferments and yoghurt ferment as ferment,
iii) obtaining hazelnut yoghurts as a result of the process of fermenting of hazelnut milks, obtained in step i), by means of the chickpea ferments obtained in step ii),
iv) obtaining hazelnut cheeses by adding hazelnut yoghurt, obtained in step iii), to the hazelnut milk obtained in step i).

In said process step i), firstly, raw hazelnuts are picked and cleaned. Raw hazelnuts are classified according to their calibers, and hazelnuts which have diameters between 10 and 12 mm are preferred for obtaining the subject matter hazelnut yoghurt. As the raw hazelnuts are picked, the galls and rotten hazelnuts are sieved and pre-cleaning processes are realized. The hazelnuts are taken to vessels with specific dimensions and they are filled with water until water covers the top of hazelnuts. The water added here is cold water and at least 24 hours must pass for waiting the hazelnuts. Here, the hazelnuts are kept in water at a temperature between 5 and 15° C. This temperature value is preferred to be 10° C. Thus, since the hazelnuts have not been subjected to any thermal process while the hazelnuts are in natural form, they can be corned without deteriorating the oil structure or without being oxidized.

As a result of keeping hazelnuts in cold, mixer, grinder or stirrer devices are used for taking wet hazelnut particles from water and for fragmenting wet hazelnuts. Water is added to obtained hazelnuts which are in powder form. Here, the mentioned hazelnut/water proportion is configured to be at a value between ½ and ¼ grams/ml by volume. The next process is passing the fragmented hazelnuts through milk cloth. The material which can be used as milk cloth is essentially a cotton woven fabric. The pore dimensions of said cotton woven fabric are at most 50 microns, and preferably milk clothes which have 30 microns or lower micron values are used. While pulp of the hazelnut powders remains in milk clothes, the liquid which can pass through the pores is evaluated as hazelnut milk. Thermal process is applied to the obtained hazelnut milk at a fixed temperature between 70 and 95° C. and preferably between 80 and 85° C. Said thermal processes are realized at duration between 8 and 10 minutes to fixed temperatures. By means of this pasteurization process of the invention applied to hazelnut milk, no preserving or flavoring substance is used, and hazelnut milk is obtained which can be preserved for long duration without deteriorating purity, taste, odor and color.

In process step ii), chickpea ferment is obtained. First of all, water is boiled at an amount of at most 200 mL for chickpea particles between 15 and 20 in number, and afterwards cooling is realized. Said chickpeas are subjected to grinding processes so as to be turned into powdered form.

Salt between 1 and 1.5 grams and chickpeas between 15-20 in number are added to said boiled-cooled water, and a mixture is obtained. The obtained mixture is incubated for duration of at least 12 hours at a temperature value between 40 and 45° C. As a result of this process, chickpea ferment is obtained.

The hazelnut milk obtained as a result of application of process steps included to process step i) is brought to fermenting temperature. Said fermenting temperature is a temperature value between 40° C. and 45° C., and preferably the temperature value is between 40° C. and 43° C. The obtained chickpea ferment is added to the hazelnut milk obtained in step i) and yoghurt ferment can be obtained as a result of these processes. Here, said hazelnut milk is at fermenting temperature. For the yoghurt ferment process, the chickpea ferment/hazelnut milk proportion is at a value between 0.01/1 and 0.05/1 mL/mL by volume, this value is preferably 0.03/1 by volume.

In step iii), the yoghurt ferment obtained in step ii) is taken at specific amounts by volume and is added to hazelnut milk obtained in step i) and brought to fermenting temperature. Here, the yoghurt ferment/hazelnut milk ratio can be at a value between 0.01/1 and 0.05/1 mL/mL by volume. The obtained mixture is incubated for at least 12 hours at a temperature between 40 and 45° C., preferably between 40 and 43° C. after some mixing actions. The incubated mixture is left for cooling at temperature of +4° C. and hazelnut yoghurt is obtained.

In process step iv), the hazelnut milk, obtained in step i), is heated to a temperature between 90 and 95° C., and hazelnut yoghurt, obtained in process step iii), is added to the heated milk. In this process step, the ratio of hazelnut milk/hazelnut yoghurt is at a value between ⅕ and 1/10 gram/gram by weight. Lemon is added at specific amounts to the hazelnut milk-hazelnut yoghurt mixture and intermittent mixing process is applied until the milk is curdled. During the mixing process, 5 grams of salt is added at most after agglomerations occur on the surface. After boiling of the mixture, the mixture is kept after processes are completed and hazelnut cheese is obtained. As the final process, the hazelnut cheese is filtered and here, the filtering process continues for at least 24 hours.

### EXAMPLE

An example product is obtained by means of the subject matter hazelnut cheese production method.
raw hazelnut with dimensions 10-11 mm has been taken,
galls and rotten hazelnuts have been cleaned,
the cleaned hazelnuts have been taken to a big vessel,
water has been added to the vessel such that water fills over the hazelnuts,
hazelnuts have been kept in cold water for 24 hours, wherein the temperature of water is 10° C.,
wet hazelnut particles have been taken, 200 grams of hazelnut have been taken to the mixer and 400 mL water has been added thereon,
this obtained mixture has been whipped by means of mixer for 5 minutes,
the obtained mixture has been passed through the milk cloth,
the obtained milk has been subjected to thermal processes, wherein the thermal process takes place at temperature between 80 and 85° C. and for 15-20 minutes, hazelnut milk has been obtained,
200 mL water has been boiled and cooled,
15-20 chickpeas and 1.5 grams of salt have been added to the water and the mixture has been obtained,
the mixture has been incubated for 12 hours at 43° C. such that the inlet is open, and chickpea ferment has been prepared,
the milk, prepared beforehand, has been brought to fermenting temperature,
the prepared 15 mL chickpea ferment has been added to 500 mL hazelnut milk at fermenting temperature,
the mixture has been mixed and has been incubated for 12 hours at 43° C. and yoghurt ferment has been prepared,
15 mL of yoghurt ferment has been added into 500 mL hazelnut milk which has been prepared beforehand and which is at ferment temperature and has been incubated for 12 hours,
afterwards, this has been left for cooling at 4° C. and hazelnut yoghurt has been obtained,
3000 grams of hazelnut milk, obtained beforehand, have been heated to a temperature value between 90-95° C.,
300 grams of hazelnut yoghurt, obtained beforehand, have been added to the heated hazelnut milk, and the mixture has been obtained,
lemon has been added to the obtained mixture,
mixing process is applied intermittently until the milk, which exists in the mixture, is curdled,
5 grams of salt have been added when the mixture begins agglomerating and when water part begins to separate, and the mixing process has been continued,
process has been continued for 5 minutes after boiling begins and hazelnut cheese has been obtained at the end of this process,
hazelnut cheese has been taken to cloth bag and the coarse water has been filtered and afterwards it has been cooled,
the inlet of the bag has been bonded and has been put into wire filter and hazelnut cheese has been obtained.

The protection scope of the present invention is set forth in the annexed claims and cannot be restricted to the illustrative disclosures given above, under the detailed description. It is because a person skilled in the relevant art can obviously produce similar embodiments under the light of the foregoing disclosures, without departing from the main principles of the present invention.

What is claimed is:

1. A production method for hazelnut cheese, wherein the hazelnut cheese does not comprise any animal product input and any animal taste and odor, and the hazelnut cheese has high nutrient values and long shelf lifetime and where high value of foods in hazelnut is pasteurized in a manner destructed at the minimum level, wherein the production method comprises the steps of:
i) obtaining hazelnut milk from the hazelnuts
applying pre-cleaning processes for providing separation of galls and rotten from the hazelnuts to obtain cleaned hazelnuts,
adding the cleaned hazelnuts into water at a temperature between 5 and 15° C. and waiting to obtain the wet hazelnut particles,
taking the wet hazelnut particles, removed from water, into mixer, grinder or stirrer devices and after adding water, fragmenting of hazelnuts by means of the mixer, grinder or stirrer devices, wherein a hazelnut/water proportion is configured to be at a value between ½ and ¼ grams/ml by volume to obtain fragmented hazelnuts,
passing the obtained fragmented hazelnuts from milk cloth and obtaining the hazelnut milk,
applying thermal processes to the hazelnut milk separated from the milk cloth,
ii) obtaining herbal ferments from chickpeas and obtaining yoghurt ferment
boiling water with scale of at most 200 mL for the chickpeas between 15 and 20 in number and cooling,
adding the chickpeas into water, adding salt and obtaining mixture and wherein the mixture is incubated at a temperature between 40 and 45° C. to obtain chickpea ferment,
bringing the hazelnut milk, obtained in step i), to fermenting temperature, wherein the fermenting temperature is a temperature value between 40 and 45° C.,
after the incubation process, the chickpea ferment is added into the hazelnut milk brought to the fermenting temperature and the yoghurt ferment is obtained, wherein a chickpea ferment/hazelnut milk proportion is a value between 0.01/1 and 0.05/1 mL/mL by volume,
iii) obtaining hazelnut yoghurts as a result of fermenting of the hazelnut milks, obtained in step i), by the chickpea ferments obtained in step ii)
adding the yoghurt ferment, obtained in step ii), into the hazelnut milks obtained in step i), wherein during the adding process, the yoghurt ferment and the hazelnut milks have temperature values between 40 and 45° C., wherein a yoghurt ferment/hazelnut milk proportion has a value between 0.01/1 and 0.03/1 mL/mL by volume,
yoghurt fermenting process is realized, is waited at incubation temperature, the temperature of the waiting process has temperature values between 40 and 45° C.,
the hazelnut yoghurt obtained after incubation process is left for cooling at temperature of +4° C.,
iv) adding the hazelnut yoghurt, obtained in step iii), to the hazelnut milk obtained in step i) and obtaining hazelnut cheeses,
heating the hazelnut milk, obtained in process step i), to a temperature between 90 and 95° C. to obtain heated hazelnut milk,
adding the hazelnut yoghurt, obtained in process step iii), to the heated hazelnut milk, and obtaining mixture, wherein a hazelnut milk/hazelnut yoghurt proportion is at a value between ⅕ and 1/10 grams/gram by weight,
adding lemon to the obtained-mixture and continuing mixing intermittently until the milk is curdled inside the mixture,
adding 5 grams of salt at most during occurrence of agglomerations at surface,
waiting for completion of the processes after starting the boiling process and obtaining the hazelnut cheese,
filtering water during taking of the hazelnut cheese and cooling.

2. The production method according to claim 1, wherein hazelnut diameters are at a value between 10 and 12 mm.

3. The production method according to claim 1, wherein the hazelnuts are kept in cold water for at least 24 hours.

4. The production method according to claim 1, wherein the milk cloth is at a maximum value of 50 microns.

5. The production method according to claim 4, wherein the milk cloth is at a value of 30 microns.

6. The production method according to claim 1, wherein the thermal process is realized at a fixed temperature between 70° C. and 95° C.

7. The production method according to claim 6, wherein the thermal process is realized at a fixed temperature between 80° C. and 85° C.

8. The production method according to claim 1, wherein the thermal process is realized for duration between 8 and 10 minutes.

9. The production method according to claim 1, wherein in process step ii), a salt amount is at a value between 1 and 1.5 grams.

10. The production method according to claim 1, wherein in process step ii), the incubation processes are realized for at least 12 hours.

11. The production method according to claim 1, wherein in process step iii), the incubation processes are realized for at least 12 hours.

12. The production method according to claim 1, wherein in step iv), after the boiling process starts, waiting process is applied for 5 minutes.

13. The production method according to claim 1, wherein in step iv), the filtering process continues at least for 24 hours.

14. Hazelnut cheese obtained by applying the production method according to claim 1.

15. The hazelnut cheese according to claim 14, wherein the hazelnut cheese comprises herbal-based components.

16. The production method according to claim 2, wherein the hazelnuts are kept in cold water for at least 24 hours.

17. The production method according to claim 2, wherein the milk cloth is at a maximum value of 50 microns.

18. The production method according to claim 3, wherein the milk cloth is at a maximum value of 50 microns.

19. The production method according to claim 2, wherein the thermal process is realized at a fixed temperature between 70° C. and 95° C.

20. The production method according to claim 3, wherein the thermal process is realized at a fixed temperature between 70° C. and 95° C.
